(19) United States
(12) Patent Application Publication
(10) Pub. No.: US 2026/0202590 A1
(43) Pub. Date: Jul. 16, 2026

(54) HIGH-COLOR GAMUT DIFFUSER PLATE AND PREPARATION METHOD THEREFOR

(71) Applicant: CHANGZHOU AOZHI POLYMER GROUP CO.,LTD, CHANGZHOU (CN)

(72) Inventors: KAI WU, CHANGZHOU (CN); JIAN ZHANG, CHANGZHOU (CN)

(21) Appl. No.: 19/558,403

(22) Filed: Mar. 5, 2026

Related U.S. Application Data
(63) Continuation of application No. PCT/CN2025/084589, filed on Mar. 25, 2025.

(30) Foreign Application Priority Data
Apr. 15, 2024 (CN) 202410449106.3

(51) Int. Cl. G02B 5/02; B82Y 20/00; G02B 1/00; G02B 1/04

(52) U.S. Cl. CPC G02B 5/0242; B82Y 20/00; G02B 1/002; G02B 1/04; G02B 5/0268

(57) ABSTRACT

The present invention discloses a high-color gamut diffuser plate and a preparation method therefor, and relates to the field of diffuser plate material technologies. In the present invention, a high-haze diffusion layer, a quantum dot layer, and a specific-spectral absorption layer are formed through in-mold co-extrusion, to prepare a high-color gamut diffuser plate. Green perovskite in the quantum dot layer works in cooperation with a visible-light absorber in the specific-spectral absorption layer, to obtain an expected spectral emissivity profile, thereby enabling the high-color gamut diffuser plate to absorb a spectrum around 580 nm (yellow). Overlap between absorption spectra of an R/G (yellow) filter is reduced as much as possible, to avoid emission leakage in other colors. An increase in the color gamut is achieved through emission spectra similar to those of the QD.

### TECHNICAL FIELD

The present invention relates to the field of diffuser plate material technologies, and specifically, to a high-color gamut diffuser plate and a preparation method therefor.

### BACKGROUND

By utilizing continuous refraction, reflection, and scattering of transmitted light rays between chemical particles and resin, the diffuser plate can enable, while shading a light-emitting source and a glaring light source, a light source to emit even, soft, and aesthetic light rays, thereby achieving a comfortable effect of translucent opacity. Compared with conventional CCFL backlights, LED backlights have many advantages such as a high color gamut, high brightness, a long service life, energy-saving and environmental friendliness, and real-time color control. The high-color gamut LED backlights enable screens of electronic products, such as televisions, mobile phones, and tablet computers, using the high-color gamut LED backlights to display more vivid colors and achieve higher color rendition. To make colors of display screens more perfect, have richer color degrees, and closer to the real-world colors, researchers have been dedicated to finding ways to increase color gamut values of LED backlit display screens.

A conventional application method for improving a color gamut is to add a QD film or a QD sheet, which not only is costly, but also requires a water-oxygen barrier layer, resulting in a large color coordinate offset over long-term use, or to use a light absorption film (LAS film) to increase a color gamut, resulting in high coating costs and a color gamut lower than that of the QD film.

The invention patent whose publication number is CN114236655A discloses a diffuser plate with a multi-layer co-extruded structure, an application thereof, and a preparation method therefor, including: an upper protective layer, an intermediate optical layer group, and a lower protective layer, where the intermediate optical layer group is arranged between the upper protective layer and the lower protective layer. The diffuser plate with a multi-layer co-extruded structure has high brightness, is integrated with a high color gamut of light enhancement and scattering, can satisfy requirements of the novel display field. However, quantum dots in a quantum dot layer are prone to thermal migration during the high-temperature co-extrusion, resulting in uneven and irregular distribution of the quantum dots within the quantum dot layer, thereby affecting the optical performance of the diffuser plate.

### SUMMARY OF THE INVENTION

An objective of the present invention is to provide a high-color gamut diffuser plate with a higher color gamut and a better optical effect.

To resolve the foregoing technical problems, the present invention provides the following technical solution: A high-color gamut diffuser plate is provided, including a high-haze diffusion layer, a quantum dot layer, and a specific-spectral absorption layer that are sequentially laminated, where the high-haze diffusion layer includes the following components in mass percentage: 8 to 12% of masterbatch and the rest being polystyrene; the quantum dot layer includes the following components in mass percentage: 1 to 3% of green perovskite, 4 to 6% of masterbatch, and the rest being polystyrene; and the specific-spectral absorption layer includes the following components in mass percentage: 0.3 to 0.7% of visible-light absorber, 3 to 6% of masterbatch, and the rest being polystyrene.

Preferably, the high-haze diffusion layer preferably includes the following components in mass percentage: 9 to 11% of masterbatch and the rest being polystyrene; the quantum dot layer preferably includes the following components in mass percentage: 1.5 to 2.5% of green perovskite, 4.5 to 5.5% of masterbatch, and the rest being polystyrene; and the specific-spectral absorption layer preferably includes the following components in mass percentage: 0.4 to 0.6% of visible-light absorber, 4 to 5% of masterbatch, and the rest being polystyrene.

Preferably, a thickness ranges from 1.8 to 2 mm, a thickness of the high-haze diffusion layer is 4 to 8% of the thickness of the high-color gamut diffuser plate; and a thickness of the specific-spectral absorption layer is 4 to 8% of the thickness of the high-color gamut diffuser plate.

Preferably, the masterbatch includes the following components in mass percentage: 14 to 18% of light diffuser and the rest being polystyrene, where the light diffuser is silicon dioxide.

Preferably, the masterbatch is prepared by mixing components and then granulating by using a twin-screw granulator.

Preferably, the green perovskite is green quantum dots with a particle size of 2 to 3 nm.

Preferably, an absorption spectrum range of the visible-light absorber is 560 to 580 nm.

To resolve the foregoing technical problems, the present invention provides the following technical solution: A preparation method for a high-color gamut diffuser plate is provided, where after components of a high-haze diffusion layer, a quantum dot layer, and a specific-spectral absorption layer are prepared according to mass percentage ratios, a high-haze diffusion layer sheet layer, a quantum dot layer sheet layer, and a specific-spectral absorption layer sheet layer that are sequentially laminated are formed through in-mold co-extrusion forming, to prepare a high-color gamut diffuser plate.

Preferably, an extrusion speed is 3 to 3.2 m/min.

Preferably, respective thicknesses of the high-haze diffusion layer, the quantum dot layer, and the specific-spectral absorption layer are controlled by controlling rotation speeds of component metering pumps of the high-haze diffusion layer, the quantum dot layer, and the specific-spectral absorption layer.

Compared with the related art, the present invention achieves the following beneficial effects:

In the present invention, a high-haze diffusion layer, a quantum dot layer, and a specific-spectral absorption layer are formed through in-mold co-extrusion, to prepare a high-color gamut diffuser plate. Green perovskite in the quantum dot layer works in cooperation with a visible-light absorber in the specific-spectral absorption layer, to obtain an expected spectral emissivity profile, thereby enabling the high-color gamut diffuser plate to absorb a spectrum around 580 nm (yellow). Overlap between absorption spectra of an R/G (yellow) filter is reduced as much as possible, to avoid emission leakage in other colors. An increase in the color gamut is achieved through emission spectra similar to those of the QD. The high-color gamut diffuser plate also implements an absorption effect to some extent on a blue wave band part, resulting in a loss of overall brightness. In addition, brilliance is increased, and color coordinates are low, making it suitable for KSF-encapsulated light strips. Furthermore, through spectrogram analysis and color gamut coverage area calculation, the DCI-P3 value and occlusion performance are also improved.

### BRIEF DESCRIPTION OF THE DRAWINGS

FIG. 1 is a schematic structural diagram of a high-color gamut diffuser plate according to the present invention;

FIG. 2 is a diagram of a spectral emission principle of a high-color gamut diffuser plate according to the present invention;

FIG. 3 is a spectral emission chromatogram of a high-color gamut diffusion plate according to Example 1 of the present invention;

FIG. 4 is a DCI-P3 color gamut diagram of a high-color gamut diffuser plate according to Example 1 of the present invention;

FIG. 5 is a schematic color gamut diagram of a diffuser plate according to a comparative example; and

FIG. 6 is a spectral emission chromatogram of a diffusion plate according to a comparative example.

### DETAILED DESCRIPTION OF THE EMBODIMENTS

The technical solutions in the embodiments of the present invention are described below clearly and completely with reference to the embodiments of the present invention.

A preparation method for green perovskite (CH₃NH₃PbBr₃ quantum dots) used in the present invention is obtained by referring to Example 3 of the application number CN104861958A. The visible-light absorber VL-580 is produced by Jiangxi LOTCHEM Co., Ltd.; and the light diffuser, silicon dioxide, is produced by Anhui Xinjingtong New Material Technology Co., Ltd.

The masterbatch of the invention is prepared by mixing the light diffuser, silicon dioxide, with polystyrene and then granulating by using a twin-screw granulator.

(Example 1)

Mass percentages of components in this example were as follows:

masterbatch: 14% of light diffuser and the rest being polystyrene;

a high-haze diffusion layer with a thickness of 0.15 mm: 8% of masterbatch and the rest being polystyrene;

a quantum dot layer with a thickness of 1.7 mm: 1% of green perovskite, 4% of masterbatch, and the rest being polystyrene; and

a specific-spectral absorption layer with a thickness of 0.15 mm: 0.3% of visible-light absorber, 3% of masterbatch, and the rest being polystyrene.

In this example, a preparation method for high-color gamut diffuser plate was as follows:

After components of a high-haze diffusion layer, a quantum dot layer, and a specific-spectral absorption layer were prepared according to mass percentage ratios, a high-haze diffusion layer sheet layer, a quantum dot layer sheet layer, and a specific-spectral absorption layer sheet layer that were sequentially laminated were formed through in-mold co-extrusion forming, where an extrusion speed was 3 m/min, to prepare a high-color gamut diffuser plate. Respective thicknesses of the high-haze diffusion layer, the quantum dot layer, and the specific-spectral absorption layer were controlled by controlling rotation speeds of component metering pumps of the high-haze diffusion layer, the quantum dot layer, and the specific-spectral absorption layer.

(Example 2)

Mass percentages of components in this example were as follows:

masterbatch: 16% of light diffuser and the rest being polystyrene;

a high-haze diffusion layer with a thickness of 0.15 mm: 10% of masterbatch and the rest being polystyrene;

a quantum dot layer with a thickness of 1.7 mm: 2% of green perovskite, 5% of masterbatch, and the rest being polystyrene; and

a specific-spectral absorption layer with a thickness of 0.15 mm: 0.5% of visible light absorber, 4% of masterbatch, and the rest being polystyrene.

In this example, a preparation method for high-color gamut diffuser plate was as follows:

After components of a high-haze diffusion layer, a quantum dot layer, and a specific-spectral absorption layer were prepared according to mass percentage ratios, a high-haze diffusion layer sheet layer, a quantum dot layer sheet layer, and a specific-spectral absorption layer sheet layer that were sequentially laminated were formed through in-mold co-extrusion forming, where an extrusion speed was 3.1 m/min, to prepare a high-color gamut diffuser plate. Respective thicknesses of the high-haze diffusion layer, the quantum dot layer, and the specific-spectral absorption layer were controlled by controlling rotation speeds of component metering pumps of the high-haze diffusion layer, the quantum dot layer, and the specific-spectral absorption layer.

(Example 3)

Mass percentages of components in this example were as follows:

masterbatch: 18% of light diffuser and the rest being polystyrene;

a high-haze diffusion layer with a thickness of 0.15 mm: 12% of masterbatch and the rest being polystyrene;

a quantum dot layer with a thickness of 1.7 mm: 1 to 3% of green perovskite, 6% of masterbatch, and the rest being polystyrene; and

a specific-spectral absorption layer with a thickness of 0.15 mm: 0.7% of visible light absorber, 6% of masterbatch, and the rest being polystyrene.

In this example, a preparation method for high-color gamut diffuser plate was as follows:

After components of a high-haze diffusion layer, a quantum dot layer, and a specific-spectral absorption layer were prepared according to mass percentage ratios, a high-haze diffusion layer sheet layer, a quantum dot layer sheet layer, and a specific-spectral absorption layer sheet layer that were sequentially laminated were formed through in-mold co-extrusion forming, where an extrusion speed was 3.2 m/min, to prepare a high-color gamut diffuser plate. Respective thicknesses of the high-haze diffusion layer, the quantum dot layer, and the specific-spectral absorption layer were controlled by controlling rotation speeds of component metering pumps of the high-haze diffusion layer, the quantum dot layer, and the specific-spectral absorption layer.

(Example 4)

Mass percentages of components in this example were as follows:

masterbatch: 16% of light diffuser and the rest being polystyrene;

a high-haze diffusion layer with a thickness of 0.10 mm: 10% of masterbatch and the rest being polystyrene;

a quantum dot layer with a thickness of 1.7 mm: 2% of green perovskite, 5% of masterbatch, and the rest being polystyrene; and

a specific-spectral absorption layer with a thickness of 0.10 mm: 0.5% of visible-light absorber, 4% of masterbatch, and the rest being polystyrene.

In this example, a preparation method for high-color gamut diffuser plate was as follows:

After components of a high-haze diffusion layer, a quantum dot layer, and a specific-spectral absorption layer were prepared according to mass percentage ratios, a high-haze diffusion layer sheet layer, a quantum dot layer sheet layer, and a specific-spectral absorption layer sheet layer that were sequentially laminated were formed through in-mold co-extrusion forming, where an extrusion speed was 3.1 m/min, to prepare a high-color gamut diffuser plate. Respective thicknesses of the high-haze diffusion layer, the quantum dot layer, and the specific-spectral absorption layer were controlled by controlling rotation speeds of component metering pumps of the high-haze diffusion layer, the quantum dot layer, and the specific-spectral absorption layer.

(Example 5)

Mass percentages of components in this example were as follows:

masterbatch: 16% of light diffuser and the rest being polystyrene;

a high-haze diffusion layer with a thickness of 0.13 mm: 10% of masterbatch and the rest being polystyrene;

a quantum dot layer with a thickness of 1.7 mm: 2% of green perovskite, 5% of masterbatch, and the rest being polystyrene; and

a specific-spectral absorption layer with a thickness of 0.13 mm: 0.5% of visible-light absorber, 4% of masterbatch, and the rest being polystyrene.

In this example, a preparation method for high-color gamut diffuser plate was as follows:

After components of a high-haze diffusion layer, a quantum dot layer, and a specific-spectral absorption layer were prepared according to mass percentage ratios, a high-haze diffusion layer sheet layer, a quantum dot layer sheet layer, and a specific-spectral absorption layer sheet layer that were sequentially laminated were formed through in-mold co-extrusion forming, where an extrusion speed was 3.1 m/min, to prepare a high-color gamut diffuser plate. Respective thicknesses of the high-haze diffusion layer, the quantum dot layer, and the specific-spectral absorption layer were controlled by controlling rotation speeds of component metering pumps of the high-haze diffusion layer, the quantum dot layer, and the specific-spectral absorption layer.

(Example 6)

Mass percentages of components in this example were as follows:

masterbatch: 16% of light diffuser and the rest being polystyrene;

a high-haze diffusion layer with a thickness of 0.10 mm: 10% of masterbatch and the rest being polystyrene;

a quantum dot layer with a thickness of 1.8 mm: 2% of green perovskite, 5% of masterbatch, and the rest being polystyrene; and

a specific-spectral absorption layer with a thickness of 0.10 mm: 0.5% of visible-light absorber, 4% of masterbatch, and the rest being polystyrene.

In this example, a preparation method for high-color gamut diffuser plate was as follows:

After components of a high-haze diffusion layer, a quantum dot layer, and a specific-spectral absorption layer were prepared according to mass percentage ratios, a high-haze diffusion layer sheet layer, a quantum dot layer sheet layer, and a specific-spectral absorption layer sheet layer that were sequentially laminated were formed through in-mold co-extrusion forming, where an extrusion speed was 3.1 m/min, to prepare a high-color gamut diffuser plate. Respective thicknesses of the high-haze diffusion layer, the quantum dot layer, and the specific-spectral absorption layer were controlled by controlling rotation speeds of component metering pumps of the high-haze diffusion layer, the quantum dot layer, and the specific-spectral absorption layer.

A structure of the high-color gamut diffuser plate according to the present invention is shown in FIG. 1. A is a high-haze diffusion layer, B is a quantum dot layer, and C is a specific-spectral absorption layer.

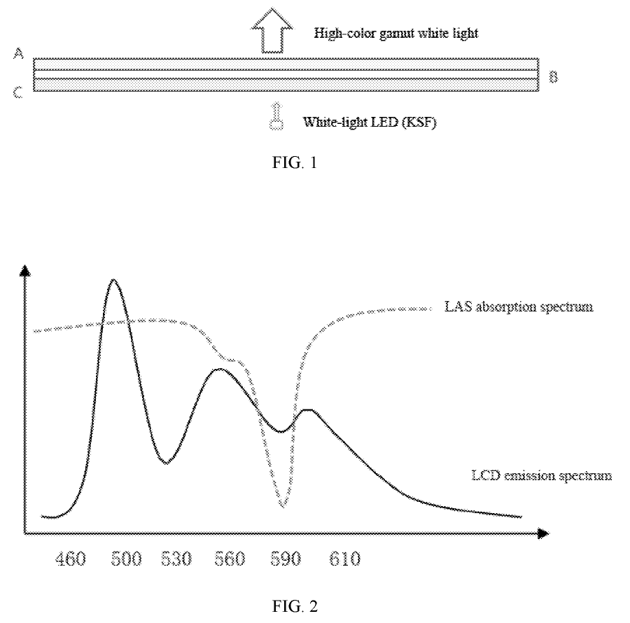

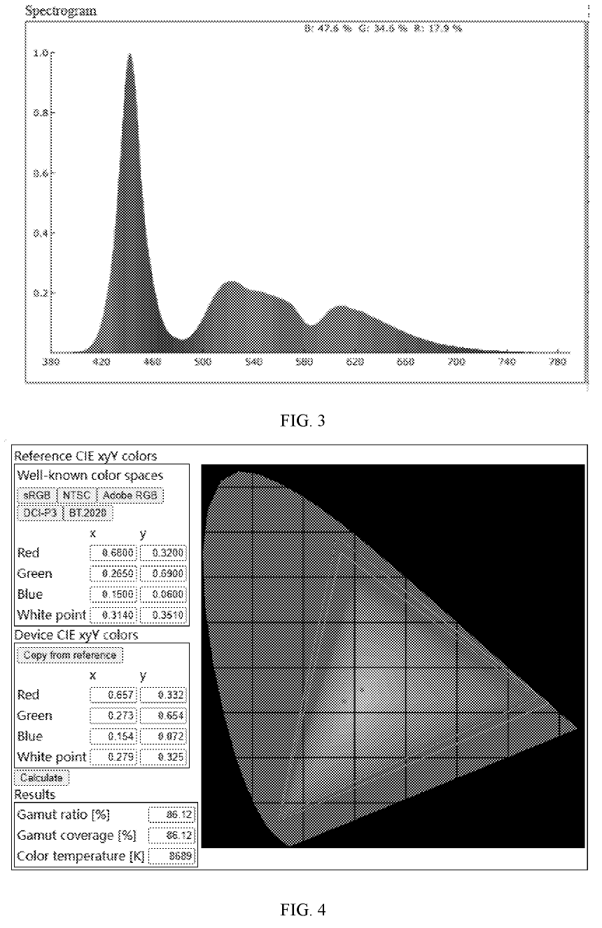

FIG. 2 is a diagram of a spectral emission principle of a high-color gamut diffuser plate according to the present invention. FIG. 3 is a spectral emission chromatogram of a high-color gamut diffusion plate according to Example 1 of the present invention. Superimposition is performed on an emission spectrum and an absorption spectrum in FIG. 2 to obtain an expected spectral emissivity profile shown in FIG. 3. In a spectrogram, a vertical coordinate is light intensity, and a horizontal coordinate is a wavelength.

A DCI-P3 color gamut diagram (calculation data tested without a screen) of the high color gamut diffusion plate according to Example 1 is shown in FIG. 4. In Example 1, transmittance of the high color gamut diffusion plate was 47%, average brilliance was 212 Nit, glossiness (JND) was 64.26, and center color coordinates were X: 0.2498 and Y: 0.2323.

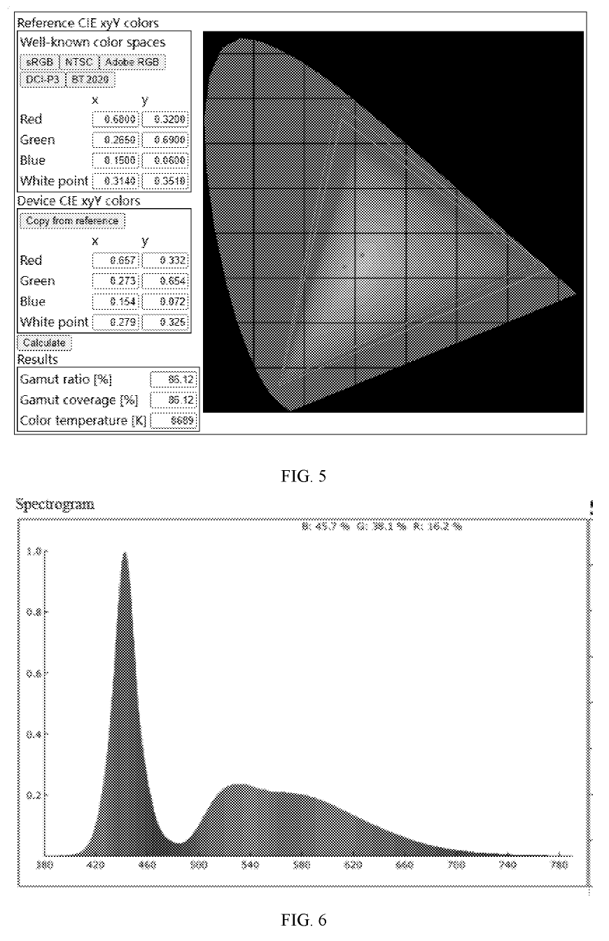

A diffuser plate in a comparative example is a mass-produced common diffuser plate, prepared by using an existing technology. A DCI-P3 color gamut diagram (calculation data tested without a screen) of the high color gamut diffusion plate according to the comparative example is shown in FIG. 5. In the comparative example, transmittance of the high color gamut diffusion plate was 29%, average brilliance was 235 Nit, glossiness (JND) was 28.32, and center color coordinates were X: 0.2640 and Y: 0.2431. A spectral emission chromatogram of the diffusion plate according to the comparative example is shown in FIG. 6.

By adding green perovskite and a visible-light absorber, a high-color-gamut diffuser plate is prepared by using the in-mold three-layer extrusion method. Therefore, brilliance can be increased, and color coordinates are low, making it suitable for KSF-encapsulated light strips. Furthermore, through spectrogram analysis and color gamut coverage area calculation, the DCI-P3 value is increased to by nearly 8%, and occlusion performance is also improved.

Obviously, the foregoing implementations are merely examples provided for clearly illustrating the implementations of the present invention, and are not intended to limit implementations of the present invention. A person of ordinary skill in the art may alternatively make other changes or modifications in different forms based on the foregoing description. It is unnecessary and impossible to exhaustively list all the implementations in this application. Moreover, the obvious changes or modifications derived from the spirit of the present invention still fall within the scope of protection of the present invention.

What is claimed is:

01. A high-color gamut diffuser plate, comprising a high-haze diffusion layer, a quantum dot layer, and a specific-spectral absorption layer that are sequentially laminated, wherein the high-haze diffusion layer comprises the following components in mass percentage: 8 to 12% of masterbatch and the rest being polystyrene; the quantum dot layer comprises the following components in mass percentage: 1 to 3% of green perovskite, 4 to 6% of masterbatch, and the rest being polystyrene; and the specific-spectral absorption layer comprises the following components in mass percentage: 0.3 to 0.7% of visible-light absorber, 3 to 6% of masterbatch, and the rest being polystyrene.

02. The high-color gamut diffuser plate according to claim 1, wherein the high-haze diffusion layer comprises the following components in mass percentage: 9 to 11% of masterbatch and the rest being polystyrene; the quantum dot layer comprises the following components in mass percentage: 1.5 to 2.5% of green perovskite, 4.5 to 5.5% of masterbatch, and the rest being polystyrene; and the specific-spectral absorption layer comprises the following components in mass percentage: 0.4 to 0.6% of visible-light absorber, 4 to 5% of masterbatch, and the rest being polystyrene.

03. The high-color gamut diffuser plate according to claim 1, wherein a thickness ranges from 1.8 to 2 mm, a thickness of the high-haze diffusion layer is 4 to 8% of the thickness of the high-color gamut diffuser plate; and a thickness of the specific-spectral absorption layer is 4 to 8% of the thickness of the high-color gamut diffuser plate.

04. The high-color gamut diffuser plate according to claim 1, wherein the masterbatch comprises the following components in mass percentage: 14 to 18% of light diffuser and the rest being polystyrene, wherein the light diffuser is silicon dioxide.

05. The high-color gamut diffuser plate to claim 1, wherein the masterbatch is prepared by mixing components and then granulating by using a twin-screw granulator.

06. The high-color gamut diffuser plate according to claim 1, wherein the green perovskite is green quantum dots with a particle size of 2 to 3 nm.

07. The high-color gamut diffuser plate according to claim 1, wherein an absorption spectrum range of the visible-light absorber is 560 to 580 nm.

08. The high-color gamut diffuser plate according to claim 1, wherein after components of a high-haze diffusion layer, a quantum dot layer, and a specific-spectral absorption layer are prepared according to mass percentage ratios, a high-haze diffusion layer sheet layer, a quantum dot layer sheet layer, and a specific-spectral absorption layer sheet layer that are sequentially laminated are formed through in-mold co-extrusion forming, to prepare a high-color gamut diffuser plate.

09. The preparation method for a high-color gamut diffuser plate according to claim 8, wherein an extrusion speed is 3 to 3.2 m/min.

10. The preparation method for a high-color gamut diffuser plate according to claim 8, wherein respective thicknesses of the high-haze diffusion layer, the quantum dot layer, and the specific-spectral absorption layer are controlled by controlling rotation speeds of component metering pumps of the high-haze diffusion layer, the quantum dot layer, and the specific-spectral absorption layer.
